(19) United States
(12) Patent Application Publication
(10) Pub. No.: US 2023/0332565 A1
(43) Pub. Date: Oct. 19, 2023

(54) INTAKE STRUCTURE OF TURBOCHARGED INTERNAL COMBUSTION ENGINE

(71) Applicant: TOYOTA JIDOSHA KABUSHIKI KAISHA, Toyota-shi (JP)

(72) Inventors: Ikuma OHNO, Toyota-shi (JP); Takashi TSUKIYAMA, Toyota-shi (JP)

(73) Assignee: TOYOTA JIDOSHA KABUSHIKI KAISHA, Toyota-shi (JP)

(21) Appl. No.: 18/298,578

(22) Filed: Apr. 11, 2023

(30) Foreign Application Priority Data
Apr. 18, 2022 (JP) 2022-068404

(51) Int. Cl. F02M 35/10; F04D 17/10; F04D 29/44; F04D 29/42

(52) U.S. Cl. CPC F02M 35/10157; F04D 17/10; F04D 29/4206; F04D 29/444

(57) ABSTRACT

An internal combustion engine includes a turbocharger and an upstream pipe. The turbocharger includes a compressor housing and a compressor wheel. The compressor wheel includes main blades and a shaft. The shaft extends parallel to the rotation axis of the compressor wheel. The main blades each project from the shaft in a direction orthogonal to the rotation axis. The main blades are spaced apart from one another in the circumferential direction. The upstream pipe includes a tubular member and guide vanes. The guide vanes each project from the inner wall surface of the tubular member. The guide vanes are spaced apart from one another in the circumferential direction. The number of the guide vanes is a prime number greater than two times the number of the main blades.

### BACKGROUND

### 1. Field

The following description relates to an intake structure of a turbocharged internal combustion engine.

### 2. Description of Related Art

Japanese Laid-Open Patent Publication No. 2010-270641 describes a turbocharger that includes a compressor housing and a compressor wheel. The compressor housing is arranged in an intake pipe. The compressor housing accommodates the compressor wheel. The compressor wheel includes a shaft and blades. The shaft extends parallel to the rotation axis of the compressor wheel. Each blade projects from the shaft in a direction orthogonal to the rotation axis. The blades are spaced apart from one another in the circumferential direction about the rotation axis of the compressor wheel.

An accommodation compartment and a guide passage are defined in the compressor housing. The accommodation compartment is used to accommodate the compressor. The guide passage is connected to one end of the accommodation compartment in the axial direction of the compressor wheel. Intake air is drawn through the guide passage into the accommodation compartment. Guide vanes having the form of plates project from an inner wall surface of the guide passage. The guide vanes are spaced apart from one another in the circumferential direction about the rotation axis of the compressor wheel.

In the above turbocharger, when the blades of the compressor wheel pass by the immediate downstream side of the guide vanes, turbulence may be produced in the intake air between two adjacent guide vanes in the circumferential direction. Such turbulence is produced as each blade passes by the immediate downstream side of a guide vane. The turbulence generated in such a manner may be recognized by a vehicle occupant as relatively high-frequency noise.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an intake structure of a turbocharged internal combustion engine is provided. The intake structure of the turbocharged internal combustion engine includes a turbocharger that includes a compressor housing and a compressor wheel accommodated in the compressor housing, and an upstream pipe connected to an upstream end of the compressor housing. The compressor wheel includes a shaft that extends parallel to a rotation axis of the compressor wheel and main blades that each project from the shaft in a direction orthogonal to the rotation axis. The main blades are spaced apart from one another in a circumferential direction about the rotation axis. A direction extending parallel to the rotation axis is a first direction. The compressor housing includes an accommodation compartment that accommodates the compressor wheel and a guide passage that is connected to an end of the accommodation compartment in the first direction and allows intake air to be drawn into the accommodation compartment. Guide vanes having the form of plates project from one or both of an inner wall surface of the upstream pipe and an inner wall surface of the guide passage. The guide vanes are spaced apart from one another in the circumferential direction. The number of the guide vanes is a prime number greater than two times the number of the main blades.

Other features and aspects will be apparent from the following detailed description, the drawings, and the claims.

### BRIEF DESCRIPTION OF THE DRAWINGS

FIG. 1 is a schematic diagram of an internal combustion engine.

FIG. 2 is a cross-sectional view showing the structure of a compressor housing.

FIG. 3 is a cross-sectional view taken along line 3-3 in FIG. 2.

FIG. 4 is a graph illustrating the intensity of intake air backflow noise and the intensity of high-frequency noise.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Structure of Internal Combustion Engine

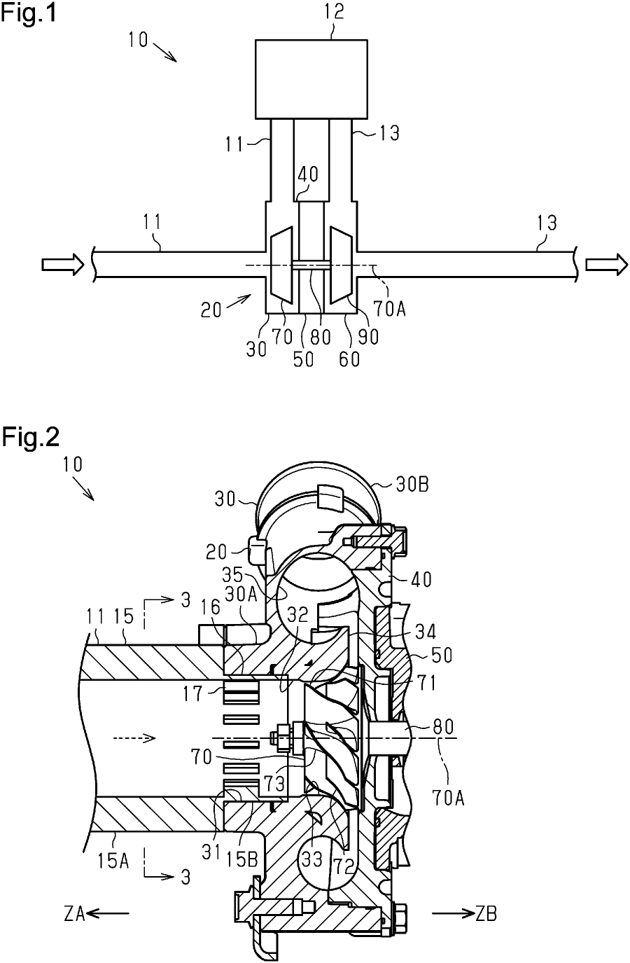

The intake structure of a turbocharged internal combustion engine according to one embodiment will now be described with reference to FIGS. 1 to 4. The structure of an internal combustion engine 10 installed in a vehicle will now be described.

As shown in FIG. 1, the internal combustion engine 10 includes an intake passage 11, an engine body 12, an exhaust passage 13, and a turbocharger 20. The engine body 12 includes cylinders (not shown). The intake passage 11 is connected to the engine body 12. The intake passage 11 draws in air from outside the internal combustion engine 10 and delivers the intake air to the cylinders of the engine body 12. The exhaust passage 13 is connected to the engine body 12. The exhaust passage 13 discharges exhaust gas from the cylinders of the engine body 12 out of the internal combustion engine 10.

As shown in FIG. 1, the turbocharger 20 includes a compressor housing 30, a seal plate 40, a bearing housing 50, a turbine housing 60, a compressor wheel 70, a coupling shaft 80, and a turbine wheel 90. The compressor housing 30 is connected to the seal plate 40. The compressor housing 30 and the seal plate 40 form a passage through which intake air flows. The compressor housing 30 and the seal plate 40 are arranged in the intake passage 11. The turbine housing 60 is arranged in the exhaust passage 13. The bearing housing 50 connects the seal plate 40 to the turbine housing 60.

The compressor housing 30 and the seal plate 40 accommodate the compressor wheel 70. The coupling shaft 80 includes a first end that is connected to the compressor wheel 70. The coupling shaft 80 includes a central portion that is accommodated in the bearing housing 50. The bearing housing 50 rotatably supports the coupling shaft 80 with bearings (not shown). The coupling shaft 80 includes a second end that is connected to the turbine wheel 90. The turbine housing 60 accommodates the turbine wheel 90. In the turbocharger 20, the turbine wheel 90, when rotated by exhaust gas flowing through the turbine housing 60, rotates the coupling shaft 80 and the compressor wheel 70. As a result, the compressor wheel 70 forces intake air through the compressor housing 30 and the seal plate 40. The turbocharger 20 is an example of a forced induction device. The internal combustion engine 10, which includes the turbocharger 20 as the forced induction device, is a turbocharged internal combustion engine.

### Structure of Compressor Housing

The structure of the compressor housing 30 will now be described. One direction extending parallel to a rotation axis 70A of the compressor wheel 70 is referred to as the first direction ZA and the opposite direction is referred to as the second direction ZB.

As shown in FIG. 2, the compressor housing 30 includes a tubular portion 30A and an arcuate portion 30B. The tubular portion 30A is substantially tubular. The center axis of the tubular portion 30A substantially coincides with the rotation axis 70A. The arcuate portion 30B is connected to the end of the tubular portion 30A in the second direction ZB. The arcuate portion 30B is arcuate and extends around the outer circumference of the tubular portion 30A. The end of the arcuate portion 30B in the second direction ZB is connected to the seal plate 40. The seal plate 40 is substantially disk-shaped. The seal plate 40 is separated in the second direction ZB from an end surface of the tubular portion 30A in the second direction ZB. The seal plate 40 closes an opening of the tubular portion 30A located toward the second direction ZB and an opening of the arcuate portion 30B located toward the second direction ZB.

The compressor housing 30 includes an insertion hole 31, a guide passage 32, an accommodation compartment 33, a connection passage 34, and a scroll passage 35. The insertion hole 31, the guide passage 32, and the accommodation compartment 33 are defined by the internal space of the tubular portion 30A. In the internal space of the tubular portion 30A, the insertion hole 31, the guide passage 32, and the accommodation compartment 33 are arranged in this order from an end in the first direction ZA toward the second direction ZB. Thus, the accommodation compartment 33 includes the end of the internal space of the tubular portion 30A in the second direction ZB. The accommodation compartment 33 accommodates the compressor wheel 70. The accommodation compartment 33 is tapered in its entirety to decrease in diameter toward the first direction ZA.

The end of the guide passage 32 in the second direction ZB is connected to the end of the accommodation compartment 33 in the first direction ZA. Intake air is drawn through the guide passage 32 into the accommodation compartment 33. The guide passage 32 is substantially cylindrical. The inner diameter of the inner wall surface of the tubular portion 30A defining the guide passage 32 is substantially equal to the inner diameter of the inner wall surface of the tubular portion 30A defining the end of the accommodation compartment 33 in the first direction ZA.

The end of the insertion hole 31 in the second direction ZB is connected to the end of the guide passage 32 in the first direction ZA. The insertion hole 31 includes the end of the internal space of the tubular portion 30A in the first direction ZA. The insertion hole 31 is substantially cylindrical. The inner diameter of the inner wall surface of the tubular portion 30A defining the insertion hole 31 is slightly greater than the inner diameter of the inner wall surface of the tubular portion 30A defining the guide passage 32.

The scroll passage 35 is the internal space of the arcuate portion 30B. The scroll passage 35 is arcuate and extends around the compressor wheel 70. The end of the scroll passage 35 at the side opposite to the accommodation compartment 33 opens toward the outside of the compressor housing 30. Further, the scroll passage 35 is connected to the intake passage 11 at the downstream side of the compressor housing 30.

The connection passage 34 is arranged between the accommodation compartment 33 and the scroll passage 35. The connection passage 34 is substantially annular. The connection passage 34 connects the accommodation compartment 33 to the scroll passage 35. The connection passage 34 is a space defined by the end surface of the tubular portion 30A in the second direction ZB and the end surface of the seal plate 40 in the first direction ZA.

As shown in FIG. 2, the compressor wheel 70 includes main blades 71, auxiliary blades 72, and a shaft 73. The shaft 73 is cylindrical in its entirety. The shaft 73 extends parallel to the rotation axis 70A. The end of the shaft 73 in the second direction ZB is connected to the end of the coupling shaft 80 in the first direction ZA. The coupling shaft 80 extends through the seal plate 40.

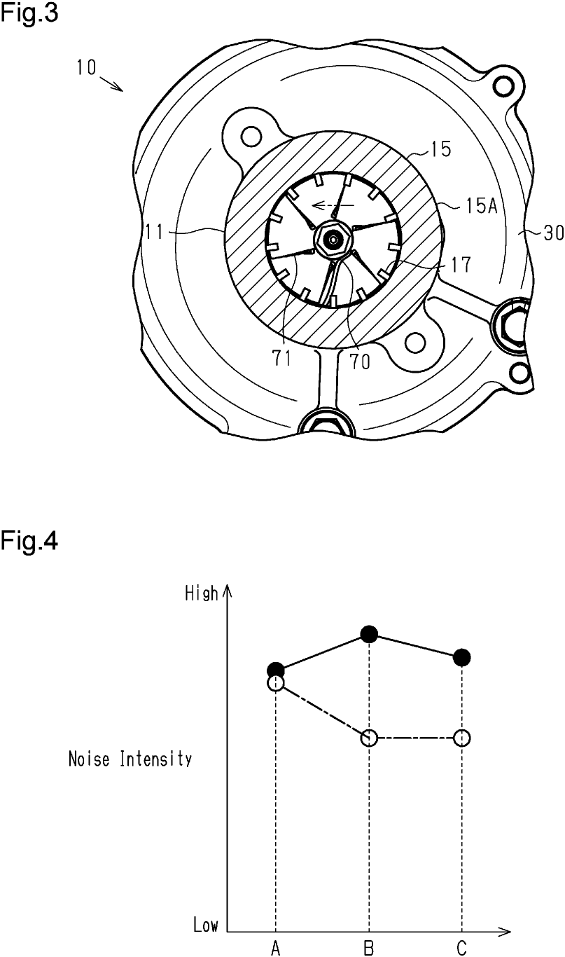

As shown in FIG. 2, each main blade 71 projects from the circumferential surface of the shaft 73 in a direction orthogonal to the rotation axis 70A. As shown in FIG. 3, the compressor wheel 70 includes six main blades 71. The six main blades 71 are spaced apart from one another in the circumferential direction about the rotation axis 70A. Further, the six main blades 71 are arranged at substantially equal intervals in the circumferential direction about the rotation axis 70A. The angle between two adjacent ones of the main blades 71 in the circumferential direction about the rotation axis 70A is approximately 60 degrees.

As shown in FIG. 2, each auxiliary blade 72 projects from the circumferential surface of the shaft 73 in a direction orthogonal to the rotation axis 70A. The auxiliary blades 72 are each arranged between two adjacent ones of the main blades 71 in the circumferential direction about the rotation axis 70A. In the present embodiment, the compressor wheel 70 includes six auxiliary blades 72. The six auxiliary blades 72 are spaced apart from one another in the circumferential direction about the rotation axis 70A. Further, the six auxiliary blades 72 are arranged at substantially equal intervals in the circumferential direction about the rotation axis 70A.

As shown in FIG. 2, with respect to the rotation axis 70A, the end of each main blade 71 in the first direction ZA is located further toward the first direction ZA from the end of each auxiliary blade 72 in the first direction ZA. Further, with respect to the rotation axis 70A, the end of each main blade 71 in the second direction ZB is located at substantially the same position as the end of each auxiliary blade 72 in the second direction ZB.

As shown in FIG. 2, the portion of the pipe defining the intake passage 11 where the upstream end of the compressor housing 30 is connected is referred to as the upstream pipe 15. The upstream pipe 15 is fixed to the compressor housing 30 at the end of the tubular portion 30A in the first direction ZA.

The upstream pipe 15 includes an intake pipe body 15A and an inlet duct 15B. The intake pipe body 15A is substantially tubular. The end surface of the intake pipe body 15A in the second direction ZB contacts the end surface of the tubular portion 30A in the first direction ZA in the compressor housing 30. The inner diameter of the intake pipe body 15A is substantially equal to the inner diameter of the inner wall surface of the tubular portion 30A defining the guide passage 32.

The inlet duct 15B includes a tubular member 16 and guide vanes 17. The tubular member 16 projects from the end of the intake pipe body 15A in the second direction ZB. The tubular member 16 is substantially tubular. The dimension of the tubular member 16 in the direction parallel to the rotation axis 70A is substantially equal to the dimension of the insertion hole 31 in the direction parallel to the rotation axis 70A. The inner diameter of the tubular member 16 is substantially equal to the inner diameter of the inner wall surface of the tubular portion 30A defining the guide passage 32. The inner diameter of the tubular member 16 is substantially equal to the inner diameter of the intake pipe body 15A. The outer diameter of the tubular member 16 is substantially equal to the inner diameter of the inner wall surface of the tubular portion 30A defining the insertion hole 31. The outer diameter of the tubular member 16 is smaller than the outer diameter of the intake pipe body 15A. The tubular member 16 is arranged in the insertion hole 31 of the compressor housing 30. The center axis of the tubular member 16 substantially coincides with the rotation axis 70A.

As shown in FIG. 2, each guide vane 17 projects from the inner wall surface of the tubular member 16 in a direction orthogonal to the rotation axis 70A. The guide vanes 17 extend from the end of the tubular member 16 in the first direction ZA toward the middle of the tubular member 16 in the direction parallel to the rotation axis 70A. Each guide vane 17 has the form of a substantially quadrangular plate. The guide vanes 17 extend parallel to the rotation axis 70A. As shown in FIG. 3, in the present embodiment, the inlet duct 15B includes thirteen guide vanes 17. As described above, the compressor wheel 70 includes the six main blades 71. Thus, the number of the guide vanes 17 is the smallest prime number greater than two times the number of the main blades 71.

As shown in FIG. 3, the thirteen guide vanes 17 are spaced apart from one another in the circumferential direction about the rotation axis 70A. The thirteen guide vanes 17 are arranged at substantially equal intervals in the circumferential direction about the rotation axis 70A. The angle between two adjacent ones of the guide vanes 17 in the circumferential direction about the rotation axis 70A is approximately 27.7 degrees.

### Operation of Present Embodiment

As indicated by the arrow of the broken line in FIG. 2, when the internal combustion engine 10 is driven, air from outside the internal combustion engine 10 is drawn into the accommodation compartment 33 through the intake pipe body 15A, the inlet duct 15B, and the guide passage 32. The intake air drawn into the accommodation compartment 33 flows through the connection passage 34 and the scroll passage 35 toward the downstream side of the compressor housing 30 in the intake passage 11. In this case, as indicated by the arrow of the double-dashed line in FIG. 3, the compressor wheel 70 is rotated counterclockwise as viewed in FIG. 3. Thus, when the main blades 71 of the compressor wheel 70 pass by the immediate downstream side of the guide vanes 17, turbulence is produced in the intake air between two adjacent ones of the guide vanes 17 in the circumferential direction about the rotation axis 70A.

### Advantages of Present Embodiment

(1) In the present embodiment, the number of the guide vanes 17 is a prime number greater than two times the number of the main blades 71. Accordingly, the angle between two adjacent ones of the guide vanes 17 in the circumferential direction about the rotation axis 70A is less than one-half of the angle between two adjacent ones of the main blades 71 in the circumferential direction about the rotation axis 70A. Thus, even if turbulence is produced in the intake air between the two adjacent ones of the guide vanes 17 in the circumferential direction about the rotation axis 70A, the turbulence will be relatively small. The decrease in the intensity of the turbulence in the intake air reduces the noise generated by the intake air turbulence. As a result, the noise generated by the intake air turbulence will not be easily recognized by a vehicle occupant or the like.

(2) As indicated by the arrow of the broken line in FIG. 2, when the internal combustion engine 10 is driven, intake air flows between the guide vanes 17. Thus, the intake air flows at portions free from the guide vanes 17. The intake air does not flow at portions where the guide vanes 17 are located. This forms streams of the intake air, the number of which is in accordance with the number of the guide vanes 17. The streams of intake air strike the ends of the main blades 71 in the first direction ZA thereby vibrating the compressor wheel 70. If the number of the main blades 71 were to be a divisor of the number of the guide vanes 17, the streams of intake air would strike the main blades 71 at substantially the same time. This would increase the vibration of the compressor wheel 70.

In this respect, the number of the guide vanes 17 is a prime number greater than two times the number of the main blades 71. Thus, the number of the main blades 71 is not a divisor of the number of the guide vanes 17. This avoids a situation in which the streams of intake air strike the main blades 71 at substantially the same time. Further, with the above structure, the number of the streams of intake air, which corresponds to the number of the guide vanes 17, is greater than two times the number of the main blades 71. Thus, the vibration of the compressor wheel 70 generated when a single stream of intake air strikes the main blades 71 is less than that when the number of the guide vanes 17 is, for example, two times the number of the main blades 71. This reduces the vibration of the compressor wheel 70.

(3) As the number of the guide vanes 17 increases, the guide vanes 17 will increase the flow resistance of the intake air. In this respect, the number of the guide vanes 17 is the smallest prime number greater than two times the number of the main blades 71. This reduces the noise generated by turbulence in the intake air and limits increases in the flow resistance of the intake air caused by the guide vanes 17.

### Noise Intensity Test

First comparative example A has substantially the same structure as the above embodiment except for the turbocharger 20 and the number of the guide vanes 17. In first comparative example A, the number of the guide vanes 17 is zero and the number of the main blades 71 is six. Further, second comparative example B has substantially the same structure as the above embodiment except for the turbocharger 20 and the number of the guide vanes 17. In second comparative example B, the number of the guide vanes 17 is seven and the number of the main blades 71 is six. Example C corresponds to the turbocharger 20 of the above embodiment. More specifically, in example C, the number of the guide vanes 17 is thirteen and the number of the main blades 71 is six.

In the turbocharger 20, some of the intake air entering the accommodation compartment 33 may flow back in the first direction ZA. The backflow of the intake air may disturb the flow of intake air around the main blades 71 of the compressor wheel 70 and generate noise. Such noise is referred to as intake air backflow noise. Further, the turbulence produced in the inlet duct 15B and the guide passage 32 may generate noise having a relatively high-frequency. Such noise is referred to as high-frequency noise. Regarding high-frequency noise, the turbulence produced in the inlet duct 15B and the guide passage 32 is, for example, turbulence of the intake air that occurs between two adjacent ones of guide vanes 17 in the circumferential direction.

The intensity of the intake air backflow noise and the intensity of the high-frequency noise were measured in first comparative example A, second comparative example B, and example C. In FIG. 4, intake air backflow noise is indicated by white circles and high-frequency noise is indicated by black circles.

As shown in FIG. 4, in first comparative example A, the intensity of the intake air backflow noise and the intensity of the high-frequency noise are both high. In second comparative example B, the intensity of the intake air backflow noise is smaller than first comparative example A. However, in second comparative example B, the intensity of high-frequency noise is greater than first comparative example A. It is understood that when the main blades 71 pass by the immediate downstream side of the guide vanes 17, turbulence is produced in the intake air between two adjacent ones of the guide vanes 17 in the circumferential direction.

In contrast, in example C, the intensity of the intake air backflow noise is smaller than first comparative example A and substantially the same as the second comparative example B. In example C, the intensity of high-frequency noise is smaller than second comparative example B. Thus, in example C, the intensity of the intake air backflow noise is less than first comparative example A, and the intensity of the high-frequency noise is less than second comparative example B.

### Modifications

The present embodiment may be modified as described below. The present embodiment and the following modifications can be combined as long as the combined modifications remain technically consistent with each other.

In the above embodiment, the structure of the compressor wheel 70 may be changed.

For example, with respect to the guide vanes 17 and the main blades 71, the compressor wheel 70 does not need to include the auxiliary blades 72.

For example, the number of the main blades 71 of the compressor wheel 70 may be changed. Specifically, the compressor wheel 70 may include five main blades 71 or less. Alternatively, the compressor wheel 70 may include seven main blades 71 or more. In this case, preferably, the number of the guide vanes 17 is a prime number greater than two times the number of the main blades 71. Further, optimally, the number of the guide vanes 17 is the smallest prime number greater than two times the number of the main blades 71.

In the above embodiment, the number of the guide vanes 17 may be changed if the number of the guide vanes 17 is a prime number greater than two times the number of the main blades 71. Specifically, when the number of the main blades 71 is six, the number of the guide vanes 17 may be seventeen, nineteen, or the like. Further, when the number of the main blades 71 is five, the number of the guide vanes 17 may be eleven, thirteen, or the like. When the number of the main blades 71 is seven, the number of the guide vanes 17 may be seventeen, nineteen, or the like.

In the above embodiment, the layout of the guide vanes 17 may be changed.

For example, the guide vanes 17 may extend from the end of the tubular member 16 in the first direction ZA to the end of the tubular member 16 in the second direction ZB. Further, the guide vanes 17 may extend from, for example, near the middle of the tubular member 16 in the direction extending parallel to the rotation axis 70A to the end of the tubular member 16 in the second direction ZB.

In the above embodiment, the guide vanes 17 may project from a different member.

For example, in addition to or in place of the tubular member 16, the guide vanes 17 may project from the inner wall surface of the guide passage 32 of the compressor housing 30.

In the above embodiment, the structure of the upstream pipe 15 may be changed.

For example, the intake pipe body 15A and the inlet duct 15B of the upstream pipe 15 may each be formed by two separate members.

For example, the upstream pipe 15 does not need to include the inlet duct 15B. In this case, the compressor housing 30 may include the guide vanes 17 that project from the inner wall surface of the guide passage 32. In this structure, the insertion hole 31 may be omitted and the guide passage 32 may extend from the end of the accommodation compartment 33 in the first direction ZA to the end of the tubular portion 30A in the first direction ZA.

In the above embodiment, the turbocharger 20 of the internal combustion engine 10 may be replaced by a supercharger as a forced induction device. In this case, the present technique regarding the number of the guide vanes 17 and the number of the main blades 71 may be applied to the supercharger.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An intake structure of a turbocharged internal combustion engine, the intake structure comprising:
a turbocharger that includes a compressor housing and a compressor wheel accommodated in the compressor housing; and
an upstream pipe connected to an upstream end of the compressor housing, wherein
the compressor wheel includes a shaft that extends parallel to a rotation axis of the compressor wheel and main blades that each project from the shaft in a direction orthogonal to the rotation axis,
the main blades are spaced apart from one another in a circumferential direction about the rotation axis,
a direction extending parallel to the rotation axis is a first direction,
the compressor housing includes an accommodation compartment that accommodates the compressor wheel and a guide passage that is connected to an end of the accommodation compartment in the first direction and allows intake air to be drawn into the accommodation compartment,
guide vanes having the form of plates project from one or both of an inner wall surface of the upstream pipe and an inner wall surface of the guide passage,
the guide vanes are spaced apart from one another in the circumferential direction, and
a number of the guide vanes is a prime number greater than two times a number of the main blades.

2. The intake structure according to claim 1, wherein
the compressor wheel includes an auxiliary blade that projects from the shaft in a direction orthogonal to the rotation axis,
the auxiliary blade is arranged between two adjacent ones of the main blades in the circumferential direction, and
the main blades each include an end in the first direction that is located toward the first direction from an end of the auxiliary blade in the first direction.

3. The intake structure according to claim 1, wherein the number of guide vanes is the smallest prime number greater than two times the number of the main blades.

4. The intake structure according to claim 1, wherein
the number of the main blades is six, and
the number of the guide vanes is thirteen.
